(19) United States
(12) Patent Application Publication
(10) Pub. No.: US 2003/0233165 A1
(43) Pub. Date: Dec. 18, 2003

(54) Computer controlled order filling system using wireless communications

(76) Inventors: Mark Hein, Napa, CA (US); David M. Chervin, Berkeley, CA (US)

Correspondence Address: Dergosits & Noah LLP, Suite 1450, Four Embarcadero Center, San Francisco, CA, 94111, US

(21) Appl. No.: 10/324,873

(22) Filed: Dec. 20, 2002

Related U.S. Application Data
(60) Provisional application No. 60/388,934, filed on Jun. 13, 2002.

(51) Int. Cl. G06F 7/00

(52) U.S. Cl. 700/216; 700/215

(57) ABSTRACT

An order filling system utilizes a server computer, a controlling computer and location verification devices to direct an orderfiller to order items stored in an inventory storage area. The server computer transmits order information to the controlling computer via wireless radio frequency communications. The controlling computer communicates with location verification devices via short range wireless communications. The controlling computer provides the orderfiller with directions and pick quantities for each inventory item in an order. The location verification devices and location clips are mounted throughout the inventory area and on the inventory carriers. The location verification devices may have a low power mode which conserves electrical power while the location verification device is not being used.

This application claims priority to pending U.S. Patent Application No. 60/388,934 filed Jun. 13, 2002 titled “Computer Controlled Order Filling System Using Wireless Communications” which is hereby incorporated by reference.

### BACKGROUND OF THE INVENTION

Manufacturing companies and distribution centers commonly have warehouses that store inventory items. When the inventory items are needed, an order is placed and the requested inventory items are picked (removed) from the storage area. An orderfiller is instructed to pick specific quantities of each order item. The orderfiller processes the order by picking (removing) the specified quantity of each order item from the inventory storage area. After all items of the order have been picked, the order items are grouped and shipped to the entity that placed the order.

Computer controlled order filling systems have been developed which assist workers in picking inventory order items. These order filling systems identify the location and quantity of order items to be picked for the orderfiller during the order filling process. These order filling systems include a controlling computer which is electrically connected by individual wires to numerous user interface devices mounted throughout a storage area. The user interface devices have visual displays that direct the orderfiller to the location of the order item and display the pick quantity of order items. After the specified quantity of the order item have been removed, the orderfiller presses a confirmation button on the user interface device to inform the computer that an inventory item has been picked. The controlling computer then directs the orderfiller to the next inventory item and the process is repeated until the worker has picked all items in the order.

A problem with the wired computer controlled order filling system is that the installation of such a system is very complicated because extensive wiring of the inventory storage area is required to set up the system. Another problem with the prior art order filling systems is that the user interface devices are not easily modified to accommodate changes in the inventory storage area. When the order filling system is changed, the user interface devices may need to be removed, rewired and reconfigured for different inventory items. The individual wiring of the user interface devices makes the order filling system extremely difficult to modify.

### SUMMARY OF THE INVENTION

The present invention is a computer controlled order filling system which utilizes wireless communications to assist an orderfiller in picking a group of items stored in an inventory storage area. The order filling system may include: a server computer, controlling computers and location verification devices. In an embodiment, the controlling computers are portable devices that move with the orderfiller and the server computer transmits order information to the controlling computer over a wireless local area network (WLAN) using radio frequency (RF) transmissions. The server computer may have RF transceiver access point stations mounted throughout the inventory storage area so that the controlling computers will always be in communications with the server computer.

The controlling computers may have various input and output devices. The controlling computer inputs may include: a wrist mounted keypad, a touchpad, a microphone with a voice recognition system, a barcode reader, an RF wristband and a cursor position controller for a graphical user interface. The controlling computer output may include: an alpha numeric display, a heads up visual display mounted in the orderfiller's field of vision, a speaker with a voice synthesizer system. The input and output devices may be wired to the controlling computer or communicate with the controlling computer through short range wireless transmitters and receivers.

During the order filling process, the controlling computer guides the orderfiller through an inventory storage area by transmitting order item location information to the orderfiller through one or more output devices. As the orderfiller travels through the inventory storage area the controlling computer communicates with location verification devices mounted throughout the inventory storage area to monitor the filling of the order. The controlling computer uses the communications with the location verification devices to check the accuracy of the items picked for the order. Each type of location verification device may interact with the controlling computer in different ways.

There are several types of location verification devices including: location verification displays, switchlights, location doorbells, doorbell displays and location clips. The controlling computer communicates with the location verification devices via short range wireless communications such as short range radio frequency signals or infrared signals.

The “location verification display” includes a wireless transceiver for communications with the controlling computer, and an alphanumeric display. During order filling, the controlling computer transmits a pick signal which is received by the location verification devices within the transmission range. If a location verification display is associated with the pick signal, the device illuminates the light to assist the orderfiller in finding the inventory item and displays the quantity of the inventory item to be picked. When the orderfiller arrives at the location verification display and presses the button, a location signal is transmitted to the controlling computer and the light and the alphanumeric display are turned off.

The “switchlight” type location verification device includes a wireless transceiver for communications with the controlling computer, a button and a light. During order filling, the controlling computer transmits a pick signal which is received by the location verification devices within the transmission range. If a switchlight is associated with the pick signal, the device illuminates the light to assist the orderfiller in finding the inventory item. When the orderfiller arrives at the switchlight and presses the button, a pick complete signal is transmitted to the controlling computer and the light is turned off.

The “doorbell” type location verification device include a wireless transmitter and a button. The orderfiller travels to the inventory item location using location information from the controlling computer. When the orderfiller finds the inventory item location, he or she presses the pick button on the doorbell. The doorbell transmits an address signal associated with the inventory item to the controlling computer. The controlling computer compares the address signal to the intended inventory pick item. The controlling computer will confirm that the orderfiller has located the inventory item or inform the orderfiller that an error has been made. The doorbell may have a very short RF transmission range so that only a receiver such as a wristband receiver which may inherently be placed in close proximity to the doorbell while signals are being transmitted.

There are several types of doorbell location verification devices each having different features. The RFID tag doorbell simply transmits the identification code when the button is pressed as described above. The “location doorbell” adds a light which is illuminated when the button is actuated. The light may confirm that the orderfiller is at the proper doorbell. The “doorbell display” is similar to the location doorbell but also includes a transceiver and a visual display. The doorbells are highly energy efficient because they do not draw power until the button is pressed. This energy efficiency is particularly useful in extending the duration of operation when the location doorbell is powered by a battery.

The doorbell display differs from the switch light because the transceiver is only activated when the orderfiller pushes the button. When the button is pressed, an address signal is transmitted to the controlling computer. The controlling computer then transmits the additional pick information. The doorbell display receives the additional information and displays the information for the orderfiller. Like the location doorbell, the doorbell display is highly energy efficient. The doorbell display is normally in a low power mode standby state. Only when the button is pressed a signal is transmitted to the controlling computer and the doorbell display remains active for a limited period of time after the button is pressed. After the active time has expired the doorbell display reenters the low power standby mode.

The “location clips” include a light and a button. One or more location clips may be electrically connected to a transceiver for short range wireless communications with the controlling computer. During the order filling process, the controlling computer transmits a pick signal which is received by the transceiver. Only the light of the location clip associated with the inventory item is illuminated. The orderfiller travels to the location clip and presses the button causing a pick complete signal to be transmitted to the controlling computer and the light to be turned off.

In an embodiment, the orderfiller fills several orders simultaneously and travels through the inventory storage area with several containers on a cart. The controlling computer informs the orderfiller of the container to place the picked inventory items into. Alternatively, location verification device(s) may be attached to the cart used to transport the picked inventory items to assist the orderfiller in determining the target container for the picked inventory items. The controlling computer transmits instructions to the location verification device on the carrier to indicate the container into which the picked items are to be placed. The light on the location verification device is illuminated to indicate the target container. The orderfiller places the picked items into the specified container and press the button on the associated location verification device. The location verification device transmits a place signal to the controlling computer which confirms the placement of the picked items. This process is repeated until the order is complete.

In the past, order filling systems required dedicating wiring for the controlling computer to communicate with the orderfiller. The present invention is compatible with these existing wired order filling systems. A wired order filling system may be modified to add location verifications devices and doorbells that communicate with the computer through wireless communications. In an embodiment, the areas of the inventory storage area having the fastest turn over inventory items may use wired user interface devices and the areas of the inventory storage area having slower turn over may utilize location verification devices and doorbells in wireless communications with the controlling computer. Because the components of the order filling system utilize wireless communications and the system components are also easily reprogrammed, the installation and maintenance of the inventive computer controlled order filling system is extremely flexible and easily installed in an inventory storage area.

Location clips may include a microprocessor, a light, a button and a transmitter. When used at an inventory storage location, the orderfiller presses the button and a signal is transmitted to the controlling computer which confirms that the orderfiller is at the proper location/inventory item. When the location clip is used with a pick container, the controlling computer may transmit a signal to a receiver on the container and one of the location clips on the container may be illuminated. The illuminated location clip informs the orderfiller of the proper location to place the picked inventory items. When the item is placed in the container, the button of the doorbell is pressed and a signal is transmitted to the controlling computer verifying the placement of the pick in the container.

The controlling computer is able to check the accuracy of the order by comparing the pick and place signals from the location verification devices and location clips with the order information. If a pick signal is transmitted that does not match the order, the controlling computer can identify the error and inform the orderfiller that a pick error has been made. More specifically, the controlling computer verifies that the order item is correct before the pick is made and indicates an error when the orderfiller is at wrong location for the pick item. Similarly, the controlling computer informs the orderfiller of an error when the picked items are placed in the wrong container so a correction can be made.

### BRIEF DESCRIPTION OF THE DRAWINGS

The invention is herein described, by way of example only, with reference to embodiments of the present invention illustrated in the accompanying drawings, wherein:

FIG. 1 illustrates a diagram illustrating the computer controlled order filling system and wireless communications paths;

FIG. 2 illustrates a diagram of an access point;

FIG. 3 illustrates a block diagram of the mobile controlling computer;

FIG. 4 illustrates a block diagram of the wrist terminal;

FIG. 5 illustrates an embodiment of the wrist terminal;

FIG. 6 illustrates a block diagram of the wrist display;

FIG. 7 illustrates an embodiment of the wrist display;

FIG. 8 illustrates a block diagram of the RFID wristband;

FIG. 9 illustrates an embodiment of the wrist terminal and touch glove;

FIG. 10 illustrates a block diagram of the touch glove;

FIG. 11 illustrates a block diagram of the controlling computer and doorbell location verification device;

FIG. 12 illustrates a block diagram of the infrared switchlight location verification device;

FIG. 13 illustrates a block diagram of the radio frequency location display location verification device;

FIG. 14 illustrates a block diagram of the infrared location display location verification device;

FIG. 15 illustrates a block diagram of the radio frequency doorbell location verification device;

FIG. 16 illustrates a block diagram of the infrared doorbell location verification device;

FIG. 17 illustrates a bock diagram of an RF doorbell display location verification device;

FIG. 18 illustrates a bock diagram of an RFID doorbell location verification device;

FIG. 19 illustrates a wristband receiver and an RFID doorbell location verification device;

FIG. 20 illustrates a group of radio frequency location clip location verification devices;

FIG. 21 illustrates a group of infrared location clip location verification devices; and

FIG. 22 illustrates an embodiment of the segmented tote with location clips.

### DETAILED DESCRIPTION

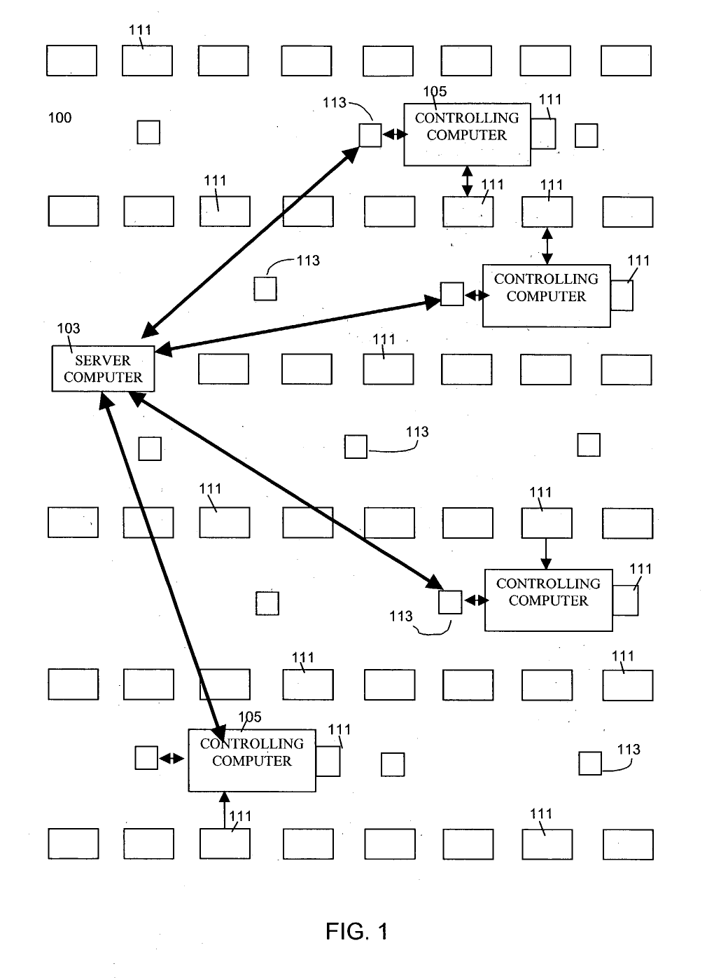

FIG. 1 illustrates an embodiment of the inventive order filling system 100 which is used to inform an orderfiller of the locations and quantities of inventory items to pick and make adjustments to orders if necessary during order filling. The inventive order filling system may include a server computer 103, controlling computers 105, access points 113 and a plurality of location verification devices 111. The server computer 103 communicates with the access points 113 mounted throughout the inventory storage area to transmit order information to the controlling computers 105. In the preferred embodiment, the server computer 103 may be an IBM RS/6000 series computer or a Hewlett Packard 9000 series computer which utilizes a wireless local area network (WLAN) to communicate with the access points. The WLAN may be an IEEE 802.11 wireless Ethernet RF network such as a Symbol Spectrum24 network or any other type of WLAN network. Alternatively, the access points may have a wired connection to the server computer.

In an embodiment, the access points 113 communicate with controlling computers 105 which travel with the orderfillers throughout the inventory storage area via wireless radio frequency (RF) signals. The access points 113 each have a limited data transmission range. In order to insure that all areas of the inventory storage area are covered, the access points 113 may be evenly distributed throughout the inventory storage area. As a controlling computer 105 travels through different regions of the inventory storage area, the access point 113 which communicates with the controlling computer 105 changes. Although the active access point 113 changes, communications between the controlling computers 105 and the server computer 103 are never interrupted. Location verification devices 111 are placed throughout the inventory storage area on the inventory storage shelves. During the order filling process, the controlling computers 105 communicate with the location verification devices 111 via short range wireless signals. The communications range may be limited, so the controlling computers 105 may only be able to communicate with location verification devices 111 which are less than about 3 meters in distance from controlling computers 105.

The controlling computer may be a wearable unit such as a backpack which moves with the orderfiller or a portable unit which are attached to a carrier and moved by the orderfiller. Or alternatively, the controlling computer may be light enough to be supported by the orderfiller. The controlling computer may include: an WLAN transceiver, a microprocessor which runs an order filling program, random access memory, read/write memory and a battery. The appropriate speed and memory of the controlling computer depends upon the size and complexity of the order filling system installation. In the preferred embodiment the controlling computers may be Pentium processor based personal computers. The controlling computer may be powered by a rechargeable battery and a solar cell. The controlling computer runs order filling software which controls the operation of the order filling system and will be described in more detail below. The software may be configured to allow the controlling computer fill multiple orders simultaneously.

In an alternative embodiment, the controlling computers may be stationary units which are networked together with each access point throughout the inventory storage area. The controlling computers and access points may be distributed so that all regions of the inventory storage area are within the communications range of at least one controlling computer. In this embodiment, the controlling computers communicate wirelessly with the orderfillers and the location verification devices through remote input/output devices such as visual displays, wrist terminals, headsets, headset speakers and microphones. In this embodiment, as the orderfiller travels through different regions of the inventory storage area, the controlling computer in communication with the orderfiller may change. The network of controlling computers may track the location of the orderfiller and may automatically transfer or share all order information to the controlling computer which is closest to the orderfiller. In this embodiment, a single controlling computer may assist multiple orderfillers simultaneously and the orderfiller remains in communication with at least one controlling computer.

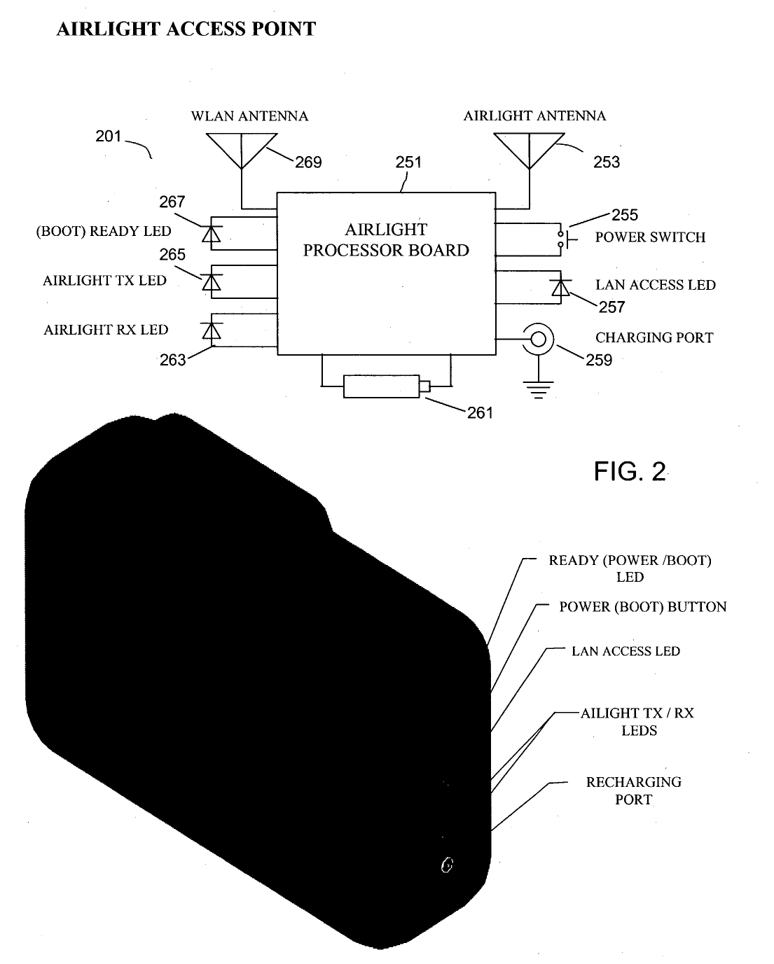

FIG. 2 illustrates an embodiment of an access point 201 which has a microprocessor 251 which is powered by a rechargeable battery 261. Electrical power may be applied to the access point 201 by turning on the power switch 255 and the charging port 259 may be used to periodically recharge the battery 261. The access point 201 may communicate with the server computer through the WLAN antenna 269 or may be directly connected to the server computer. The access point 201 may communicate with local devices through the Airlight antenna 253 which has a shorter transmission range and a different frequency than the WLAN. The access point may have various lights to indicate the status of the access point 201. When the access point 201 is operational, the ready LED 267 may be illuminated. When Airlight communications are transmitted, the Airlight Transmission LED 265 may be illuminated and when Airlight communications are received, the Airlight Receiver LED 263 may be illuminated. When signals are transmitted or received over the WLAN, the LAN Access LED may be illuminated.

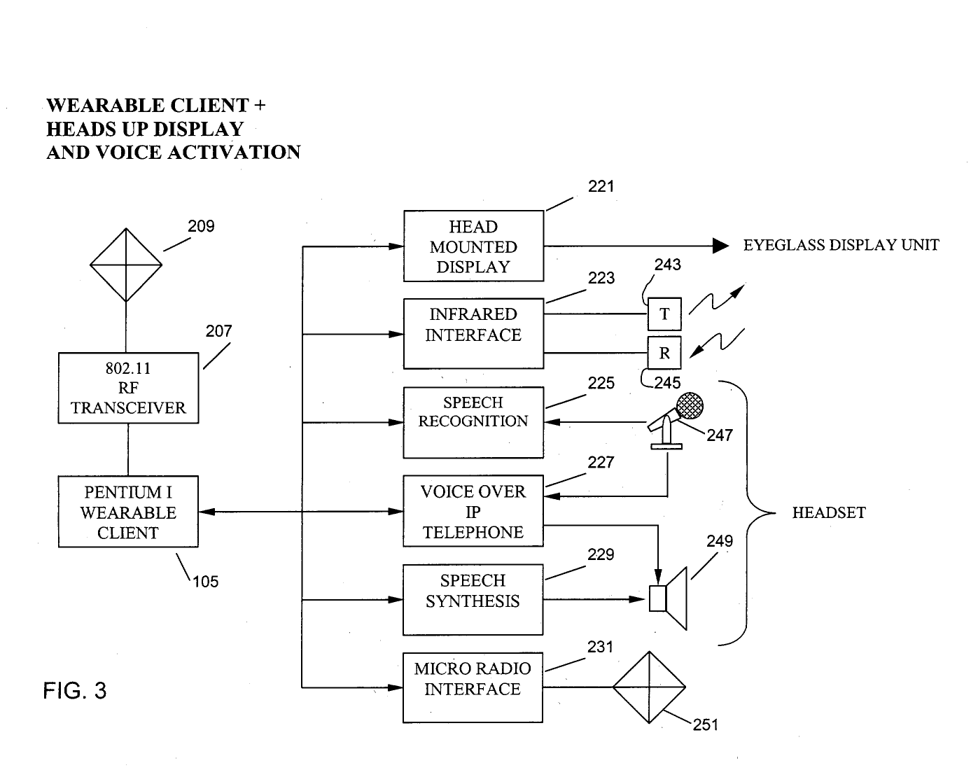

The input and output devices of the controlling computer include wearable devices which utilize a direct wire connection or wireless transceivers to communicate with the controlling computer(s). With reference to FIG. 3, the controlling computer 105 may have a wireless RF transceiver 207 and an antenna 209 for communicating with the server computer (not shown). The controlling computer 105 may have various interfaces (hardware or software) which allow communication with input and output devices connected to the controlling computer 105. For example; a head mounted display interface 221 is used with an eyeglass display unit, an infrared interface 223 is used with an infrared transmitter 243 and an infrared receiver 245, a speech recognition interface 225 is used with a microphone, a speech synthesis interface 229 is used with a speaker 249 and a micro radio interface 231 is used with a micro radio antenna 251. In an embodiment, a voice over telephone interface 227 is used with a microphone 247 and a speaker 249. In alternative embodiments, the eyeglass display unit may be replaced with a heads up visual display or a visual display mounted on a wrist terminal. Other input and output devices include: an input keypad mounted on a wrist terminal, a scanner, a wristband and a touch glove. Some of the possible input and output devices are described in more detail below.

Heads-Up Display—The heads-up display receives display information from the controlling computer and displays the information on a small screen mounted within eye sight of the orderfiller. The display screen may be small LCD type display screen or an alphanumeric display that is positioned on a small flexible arm that is attached to eyeglass frames or any other support structure that may be worn by the orderfiller. In an embodiment, the display may be about ¼ by ½ inch. The heads-up display may be built into the worker's glasses and project the display information directly onto the lenses. Although a portion of the orderfiller's view is obstructed, the majority of the view is not blocked, allowing the orderfiller to perform the required actions. If the heads-up display is connected by wires to the controlling computer, power to the heads up display is provided by the controlling computer. In an alternative embodiment, the heads-up display may communicate with the controlling computer through a wireless connection and the headset may be powered by a battery or solar power.

Voice Command Headset—The voice command headset has a speaker which provides spoken instructions to the orderfiller from the controlling computer. The controlling computer has voice synthesis software to convert output signals into spoken instructions. If the headset is connected by wires to the controlling computer, power is provided by the controlling computer. In an alternative embodiment, a wireless connection to the controlling computer may be used. If the headset has a wireless connection, a battery or solar power is used to power to headset.

Microphone—An orderfiller can use a microphone to verbally input commands or instructions to the controlling computer. The controlling computer has voice recognition software to interpret speech from the orderfiller. The microphone may have a wired connection to the controlling computer and be powered by the controlling computer. Alternatively, the microphone may have a wireless connection and may be battery or solar powered. The microphone may be built into other devices such as the wrist terminal, wrist display or wristband.

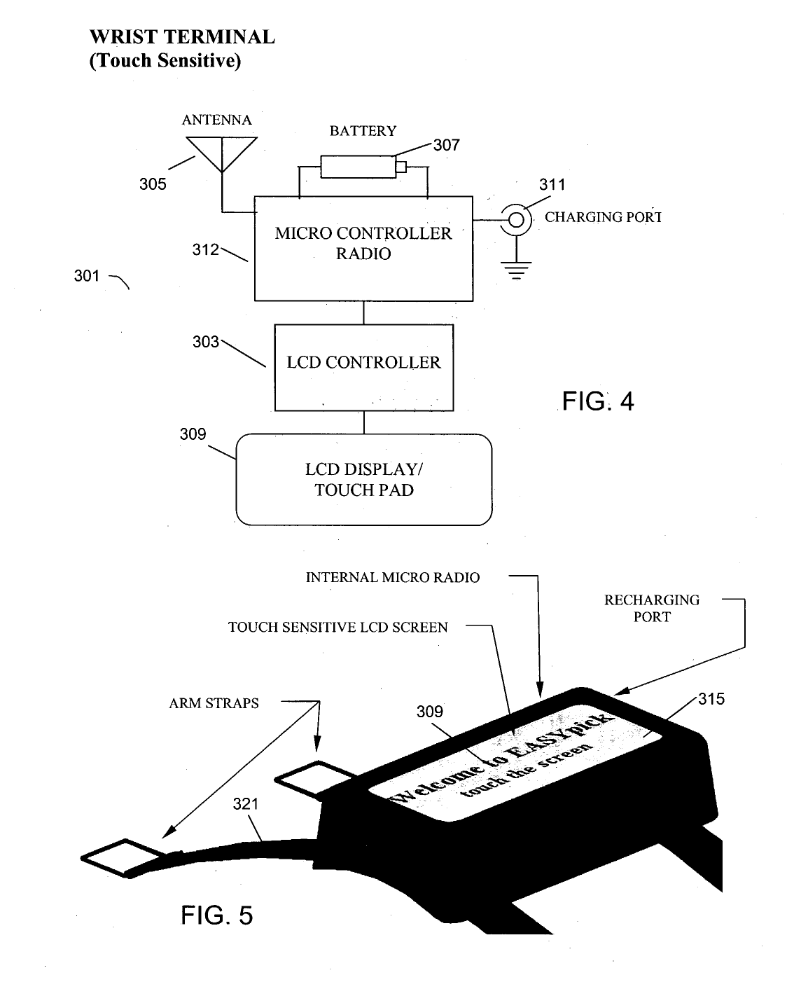

Wrist Terminal—A wrist terminal may be both an input and an output device for the controlling computer. The wrist terminal may have a keypad input with functional descriptions written on the physical keys or a touchpad. The output may be an LCD monitor, alpha numeric display such as an LED device which is built into the wrist terminal. FIG. 4 illustrates a diagram of an embodiment of the wrist terminal 301 which includes a micro controller radio 312 which is powered by a rechargeable battery 307. The battery 307 may be recharged by applying an appropriate voltage to the charging port 311. The micro controller radio 312 receives wireless RF signals from the controlling computer through an antenna 305 and displays information on an LCD display/touchpad 309 which functions as both an input and output device. The micro controller radio 312 uses an LCD controller 303 to communicate with the LCD display/touchpad 309. The orderfiller views the message on the LCD display/touchpad 309 and may respond or input information by pressing an appropriate area of the LCD display/touchpad 309.

With reference to FIG. 5, the wrist terminal 301 has arm straps 321 for attaching the device to an orderfiller is illustrated. A portion of the visual display 309 may display messages 315 and function as a touchpad input. In this embodiment, the keypad is modified through software changes rather than having to replace the buttons of the keypad. The wrist terminal may be directly connected to the controlling computer by wires or alternatively a wireless connection may be used between the controlling computer and the wrist terminal. If a wireless connection is utilized, the wrist terminal has a wireless local area network (WLAN), a personal area network (PAN) or a low speed RF transceiver. The wrist terminal is powered by batteries or solar power. In an embodiment, the entire controlling computer with input and output devices may be integrated into the wrist terminal.

Wrist Display—The wrist display is similar to the wrist terminal in that it has a visual display output device such as an LCD or LED alphanumeric display. The wrist display differs from the wrist terminal because it does not have input buttons or a touch screen. Because the wrist display does not have input buttons or a touch screen it can be made smaller, possibly the size of a wrist watch and may be attached to the orderfiller's wrist with a single strap. In an embodiment, the wrist display has a microphone for receiving voice commands from the orderfiller.

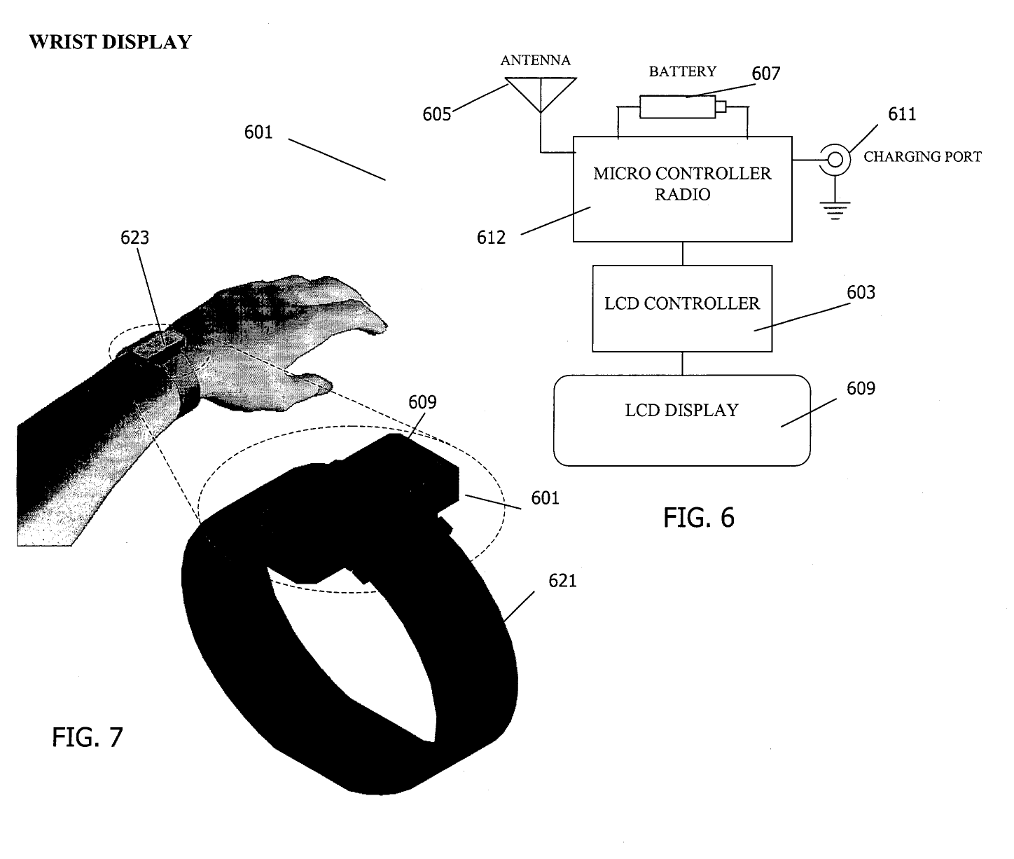

FIG. 6 illustrates a diagram of an embodiment of the wrist display 601 which includes a micro controller radio 612 which is powered by a rechargeable battery 607. The battery 607 may be recharged by applying a DC voltage to the charging port 611. The micro controller radio 612 receives wireless RF signals from the controlling computer through an antenna 605 and displays information on a visual display 609 which is an output device. In an embodiment, the wrist display 601 has a microphone (not shown) which receives voice commands from the orderfiller. The micro controller radio 612 uses an LCD controller 603 to communicate with the LCD display 609. Alternatively, a wired connection may be used between the controlling computer and the wrist display 601. The wrist display 601 is shown in FIG. 7. The wrist display 601 has a wrist strap 621 for attaching the wrist display 601 to an orderfiller's wrist 623 is illustrated. The visual display 609 may display messages 315 from the controlling computer.

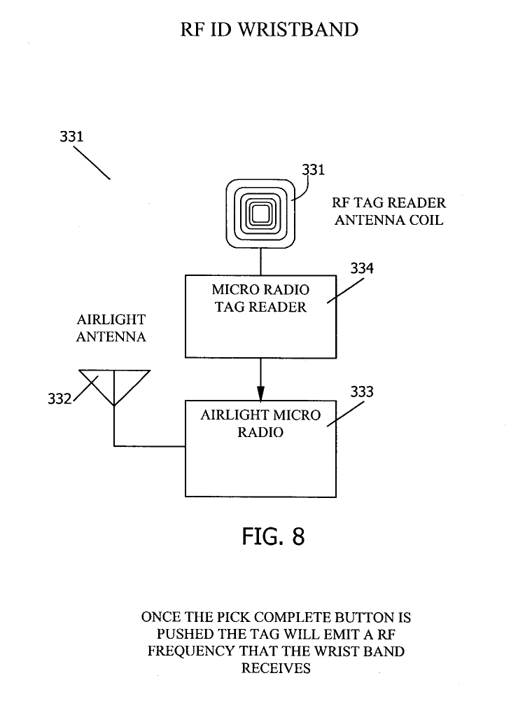

Wristband—FIG. 8 is a diagram of an RFID wristband 331 which includes an antenna 332, a micro radio 333 a micro radio tag reader 334 and an RF tag reader antenna coil 335. The wristband 331 acts as a remote receiver for the controlling computer. The components of the wristband 331 are contained in a housing which is worn on the orderfiller's wrist using a wrist strap. The wristband 331 is placed on the hand which is used to press the buttons on the location verification devices. When the orderfiller operated the buttons on the location verification device, the wristband 331 is inherently placed in close proximity to the location verification device reducing the RF transmission distance and improving communications. The wristband 331 may be used with any of the location verification devices, but may be particularly compatible with the RF ID tag doorbell which may have a very low powered RF output signal.

In an embodiment, the wristband may include a transceiver for bi-directional communications rather than only a receiver. The wristband may communicate with the controlling computer via electrical conductors or wireless communications. In another embodiment, the wristband may also include a visual display, such as an LCD which can display pick information for the orderfiller.

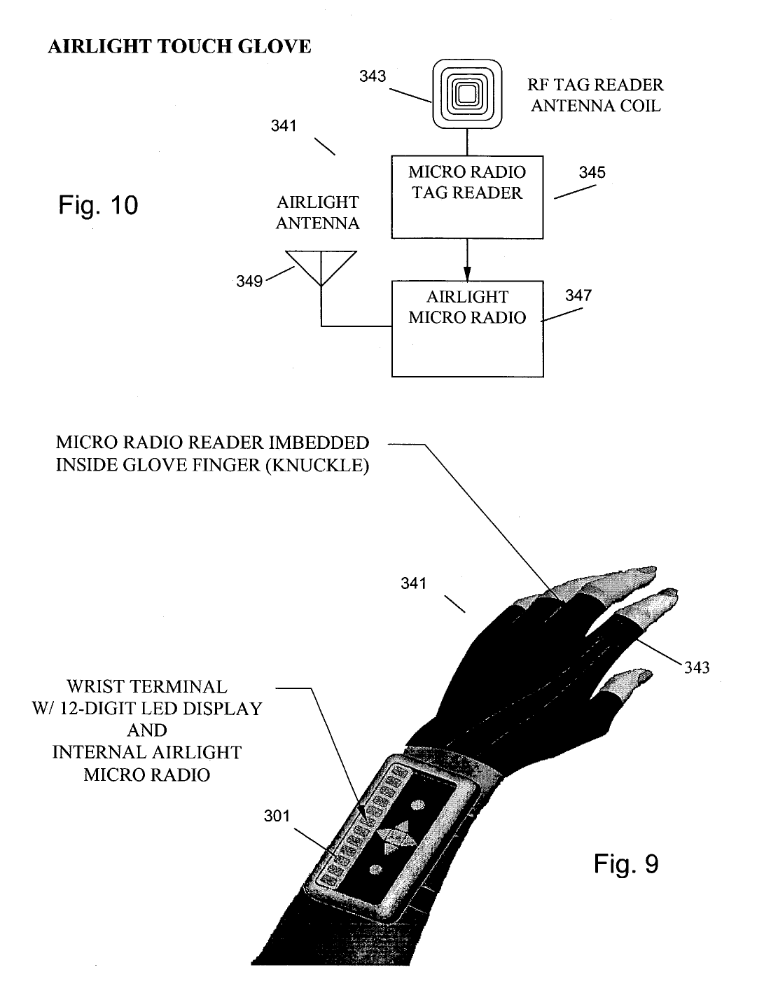

Touchglove—FIG. 9, illustrates a touchglove 341 and a wrist terminal 301 which are worn on the hand and arm of an orderfiller. The touch glove 341 has a micro radio reader 343 imbedded into or on the knuckle section of a finger. The touchglove 341 and wrist terminal 301 may communicate via wireless communications. FIG. 10 illustrates a diagram of the touchglove 341 components including an RF tag reader antenna coil 343 which is connected to a micro radio tag reader 345. The output of the micro radio tag reader 345 is sent to an airtight micro radio 347 and transmitted through the airtight antenna 349 to a controlling computer.

During order processing, the orderfiller place the RF Tag Reader Antenna Coil 343 in proximity to an RF tag (not shown). The RF Tag Reader Antenna Coil 343 transmits an RF signal to the tag and the tag returns an RF signal containing tag information. The tag information may be processed by the micro radio tag reader 345 and airtight micro radio 347 and transmitted by the airtight antenna 349 to a controlling computer. In the preferred embodiment, the receiver is in knuckle of the index finger. When exposed to a compatible wireless signal, the receiver obtains the signal and transmits the signal to the controlling computer. In an embodiment of the order filling system, radio frequency identification (RFID) labels which emit short range RFID signals are mounted throughout the storage area. The orderfiller points the micro radio tag reader 345 at the RFID label and receives identification information from the label. In an embodiment the orderfiller may have to press a button on the RFID label in order for the identification information to be transmitted. The touchglove transmits the label identification information to the controlling computer. The touch glove may need to be very close to the RFID label to correctly identify the label and avoid reading other nearby labels.

In an embodiment, the index finger of the touchglove may have both a receiver and a transmitter for communications with locations verification devices mounted on storage shelves. The touchglove may be directly wired to or may be in wireless communication with the controlling computer. If the touchglove uses wireless communications, it may have a short range transmitter and may be powered by a battery or a solar panel.

The RF tag is energy efficient because the required transmission distance to the touchglove is very short. As discussed during operation, the RF tag may not even require batteries to return an identification signal to the RF tag reader antenna coil 343. As discussed, the RF Tag Reader Antenna Coil 343 transmits an RF signal to the tag and the tag returns an RF signal containing tag information. The RF Tag may be a passive device which is made up of a microchip with a coiled antenna. When the tag reader sends out electromagnetic waves that form a magnetic field. The passive RFID tag draws power from this magnetic field and uses it to power the microchip's circuits. The chip then modulates the waves that the tag sends back to the reader and the reader converts the new waves into identification data. Because the RFID tag uses energy from the RF tag reader it does not require its own power source.

Wearable Scanner—The orderfiller may also carry a mobile scanner for reading identification information from inventory tags mounted throughout the inventory storage area. The scanner may have a microprocessor and a laser scanner engine for reading bar codes. Alternatively, the scanner may be a CCD scanner which has a CCD scanner engine and is also capable of reading bar codes. The scanner may be worn by the orderfiller with a neck strap, harness or belt clip. The scanner may be directly wired to or may be in wireless communication with the controlling computer. If the scanner uses wireless communications, the scanner may include a short range transmitter and be powered by a battery or solar panel.

The orderfiller uses a carrier to transport inventory items from the storage area to a shipping area during the order filling process. Each carrier holds one or more cartons and each carton may be used to transport the inventory items for each separate order. Inventory items are placed into the cartons during the order filling process. If the carrier holds multiple cartons, multiple orders may be processed by the orderfiller simultaneously.

The order filling system also includes location verification devices which are mounted on each inventory storage location in the storage area. The location verification devices communicate with the controlling computer and assist the orderfiller in locating inventory order items for picking. The location verification device communicates with the controlling computer and allows the controlling computer to track the progress of the order. Because short range communications are utilized, the controlling computer can only communicate with location verification devices which are in transmission range.

A location verification device may also be mounted on the carrier when the orderfiller is processing multiple orders simultaneously. The location verification device mounted on the carrier informs the orderfiller which carton on the carrier to place the picked items. The orderfiller can also acknowledge the proper placement of the picked items through the location verification device on the carrier. Because the carrier travels with the orderfiller, the location verification device on the carrier remains in continuous communication range of the controlling computer.

There are several types of location verification devices which each have different features and capabilities. A primary distinction between the location verification devices is the way in which they communicate with the controlling computer and their energy efficiency. During the order filling process, the doorbell display, switch light, location display and location clip type location verification devices can receive short range signals from the controlling computer and transmit signals to the controlling computer. Some of the doorbell type location verification devices only have short range RF transmitters and cannot receive information from the controlling computer.

The doorbells type devices are more energy efficient than the other location verification devices because they have a low energy standby mode and a normal communications mode. The doorbells are normally in standby mode waiting for an orderfiller. In the standby mode very little if any energy is consumed. When the switch is pressed, the doorbell switches from standby mode to normal communications mode. In the communications mode the doorbell transmits identification information to the controlling computer. The doorbell remains in the communications mode for a limited period of time before going back to standby mode. In the communications mode energy may also be conserved by setting the transmission range of the transmitter or transceiver to be very short, so that transmitted signals can only be detected by receivers placed in close proximity to the doorbell. Because very little energy is consumed, the doorbells are useful in applications where maximum battery life is desirable.

In contrast, other location verification devices (not doorbells) are mounted in the storage area may communicate with the controlling computer when the orderfiller moves within a much longer transmission range of the location verification device's short range transmitters. The location verification devices may always be in communications mode. Because the location verification devices have a longer communications range and may not have a low power mode, they are less energy efficient than the doorbell type devices.

The interaction of the server computer, controlling computer and location verification devices during the order filling process is described in more detail below. Although the operations of the location verification devices are different, a single order filling system-may include any combination of doorbells, switch lights and location displays. Also existing order filling systems may be modified to incorporate the wireless communications. The inventive system is compatible with older technology non-wireless user interface devices which are mounted in the inventory storage area. These older user interface devices communicate with the controlling computer at least partially via electrical signals transmitted over wires.

The orderfiller begins the order filling process by logging in the controlling computer with the server computer. The log in process includes transmitting order information from the server computer to the mobile client computer and may include associating the controlling computer with a carrier and other peripheral devices such as wrist terminals and scanners. After logging in, the controlling computer directs the orderfiller to an inventory item location by displaying directions or location information on the visual display such as a heads up display or wrist terminal. The orderfiller goes to the first displayed order item in the storage area. When orderfiller gets close to the location verification device the controlling computer communicates with the location verification device associated with the inventory item. As discussed, the interaction between the controlling computer and the inventory item location verification device depends upon the type of location verification device.

During order filling, the controlling computer directs the orderfiller to the inventory item on the order and transmits a short range pick signal associated with the inventory item. The controlling computer directs the orderfiller to the inventory item. When the orderfiller moves within transmission range, the switch light, location display or location clip associated with the inventory item responds to the pick signal by illuminating a light. The light assists the orderfiller in finding the inventory item storage location. If the location verification device is a doorbell, a light is not illuminated. The orderfiller presses a button on the doorbell so the doorbell sends an identification signal to the controlling computer which verifies the correct location.

Once the orderfiller is at the correct location, the controlling computer informs the orderfiller of the pick quantity for the inventory item. The pick quantity can be displayed on a visual display of the controlling computer. If the location verification device has a visual display the pick quantity is also displayed on the location verification device. The orderfiller picks the specified quantity of the inventory item from the storage area and presses the “pick complete” button on the location verification device or on a controlling computer input device such as a touchpad or wrist terminal. The location verification device turns off the light on the location verification device and transmits a wireless pick complete signal to the controlling computer. The controlling computer receives the pick complete signal and transmits a clear signal to remove all information on the location verification device for the inventory item that was picked.

After a pick is complete, the orderfiller is directed to the location of the next order item by the controlling computer. The described order filling process is repeated for all order items until the order is completed. Once the order is completed, the inventory items are transported to a central area where they are shipped or combined with other orders and shipped out of the inventory storage area.

During the filling of an order, if the specified quantity of an inventory item is not available, the order can be adjusted. The order can be adjusted by inputting information through the controlling computer input device. The orderfiller determines that the specified quantity is not available and makes an adjustment to the order by pressing the “adjust quantity” button on the wrist terminal or location verification device keypad. The controlling computer may respond by displaying the original order quantity on the visual display of the wrist terminal. The keypad is used to adjust the original order quantity to the actual quantity of items picked. When the visual display is adjusted to the actual pick quantity, the orderfiller can press the “Done” button twice to confirm the adjusted quantity and to indicate that the pick is complete. The described pick adjustment method is an example of an adjustment procedure which is dictated by software. Various other methods of adjusting the pick quantity are possible.

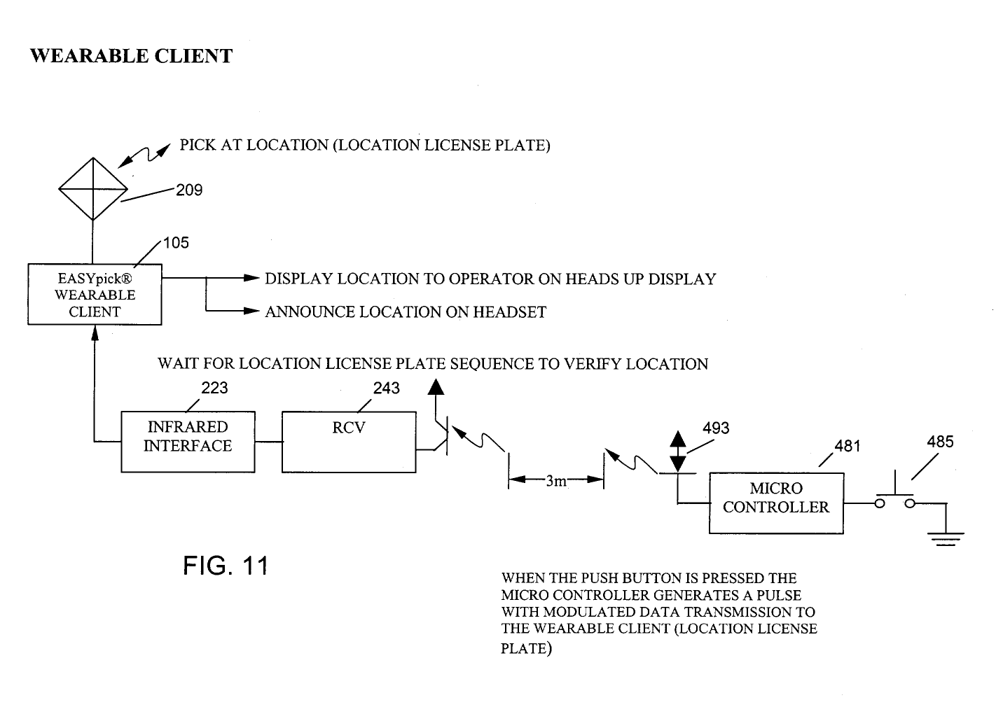

FIG. 11 is a diagram of a controlling computer 105 and a doorbell type location verification device 481 which transmits location information to the controlling computer 105 via infrared signals. During order processing, the orderfiller finds the location of the inventory item and presses the location verification button 485. An electrical signal is sent to the infrared transmitter 493 to activate the sending of a location signal. The location information stored in the micro-controller of the location verification device 481 is transmitted from the infrared transmitter 493 as a wireless infrared signal. The infrared receiver 243 receives the location information which is then processed by the infrared interface 223 of the controlling computer 105. If the transmitted location information matches the order information, the controlling computer 105 informs the orderfiller that he or she is at the correct location and allows the orderfiller to pick order item. If the location information does not match order information, the orderfiller is instructed to find the correct inventory item location. Although the operation description specifies that location information is transmitted, any other type of identification information can be transmitted and used in the same way. For example, a specific inventory item identification code can be used rather than location information.

As described, communications between the controlling computer and the location verification devices may vary depending upon the configuration of the location verification devices. The communications may be unidirectional rather or bi-directional. The transceivers may be radio frequency or infrared. The transmission range of the transceivers may be very short such as a personal area network or medium length of several meters. The switchlights, location displays, doorbells and location clip type location verification devices and the communications between these devices and the controlling computer are described in more detail below.

The switchlight type location verification device contains: a microprocessor, a pick complete button, an LED and a short range transceiver. During the order filling process when the controlling computer transmits a signal for an active pick at the switchlight location, the short range transceiver receives the signal and illuminates the LED. The orderfiller sees the LED and goes to the inventory storage location. The quantity of the inventory item to pick is indicated on an output device of the controlling computer such as a heads-up display or a wrist terminal. After removing the specified quantity of the inventory item the orderfiller presses the pick complete button on the switchlight and the switchlight sends a pick confirmation signal to the controlling computer. Alternatively, the orderfiller can press a pick complete button on an input device to the controlling computer. Short range communications between the controlling computer and the switchlight may be either through RF or infrared signals.

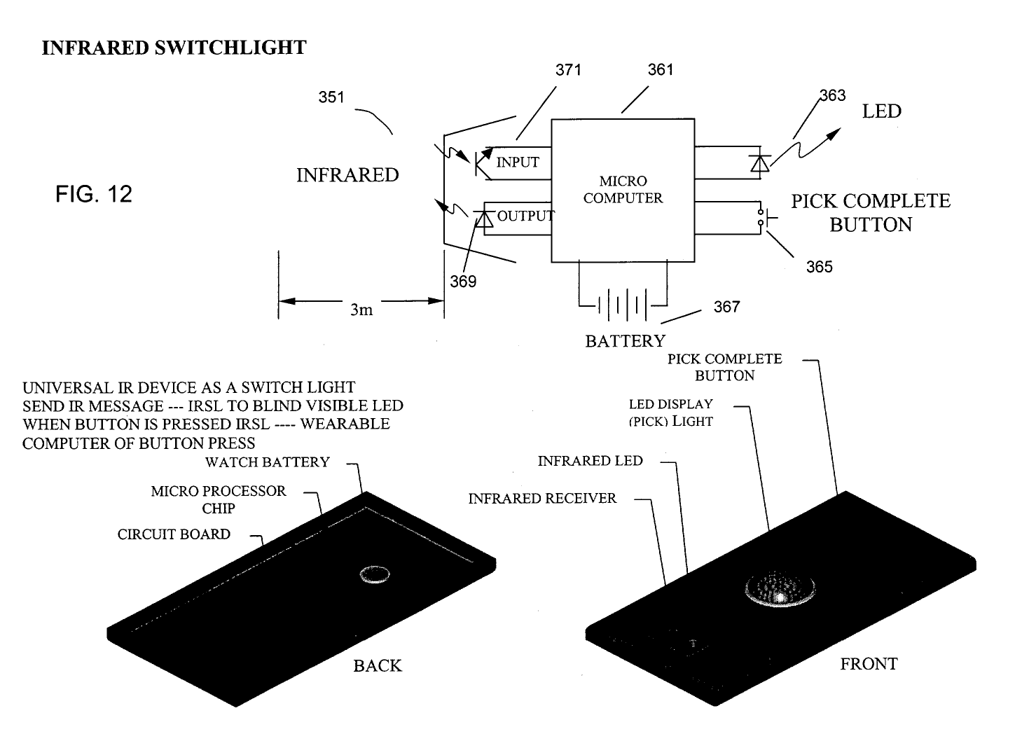

FIG. 12 illustrates a diagram of an infrared type switchlight 351 having a microprocessor 361 powered by a battery 367. The switchlight 351 receives information through the infrared receiver 371. The information may be transmitted from an infrared transmitter of the controlling computer as described above. When the switchlight 351 receives the active pick signal, it processes the signal and illuminates the LED 363. When the orderfiller presses the pick complete button 365 the microprocessor 361 extinguishes the LED 363 and transmits a pick complete signal through the infrared transmitter 369 to the controlling computer. The infrared transmitter 369 may have a range of about 3 meters. In an RF embodiment of the switchlight, the infrared receiver is replaced with an RF receiver and the infrared transmitter 369 is replaced with an RF transmitter.

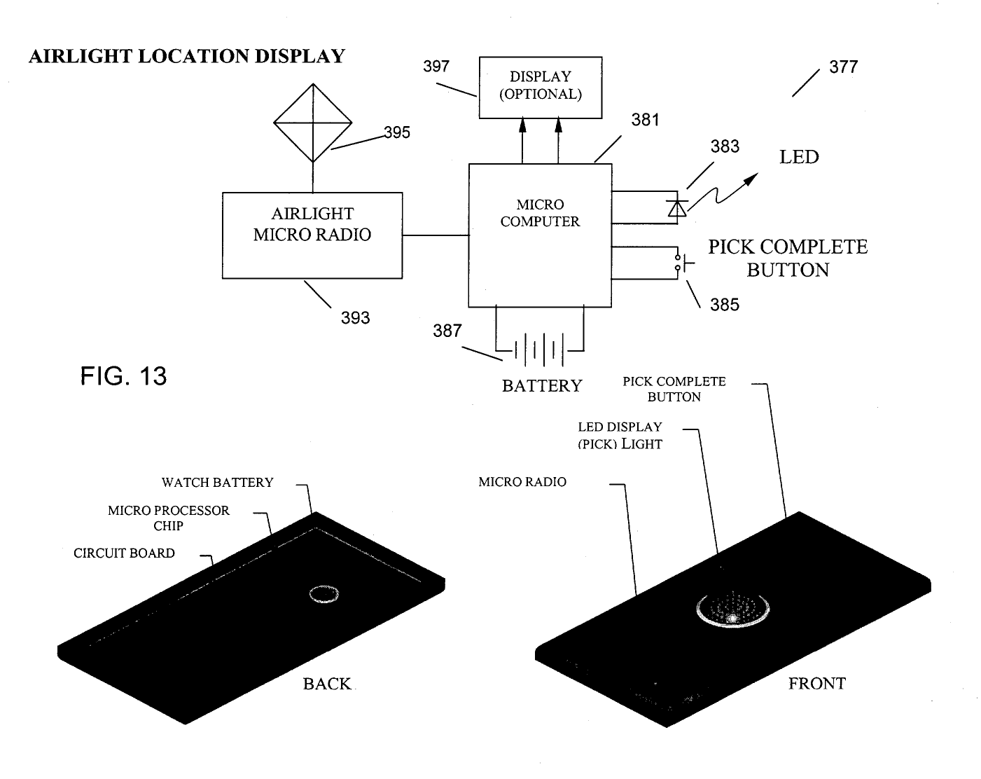

The “location display” type location verification device is similar to the switchlight but has the added feature of an alphanumeric display for displaying the pick quantity. FIG. 13 illustrates an RF embodiments of the location display. The location display 377 contains: a microprocessor 381, a battery 387, a pick complete button 385, an LED 383, an LCD display 397, an RF transceiver 393 and an antenna 395. The location displays 377 may also include data entry buttons or touch screens.

During the order filling process, the controlling computer transmits a short range active pick signal as the orderfiller travels through the inventory storage area. The active pick signal is received by the location display device when orderfiller gets close. The short range RF transceiver 393 and antenna 395 receive the pick signal. The location display 377 responds to the pick signal by illuminating the LED 383 and displaying the pick quantity on the LCD display 397. The orderfiller sees the LED 383 and travels to the inventory storage location. The orderfiller sees the LCD 397 indicating the pick quantity and removes the specified quantity of inventory items from the storage location. The orderfiller then presses the pick complete button 385. The location display 377 transmits a pick confirmation signal to the controlling computer. If quantity adjustments are necessary, the adjusted quantity can be input through function buttons on the location display or controlling computer keypad. After the adjustment is entered, the location display 377 transmits the adjusted pick information to the controlling computer.

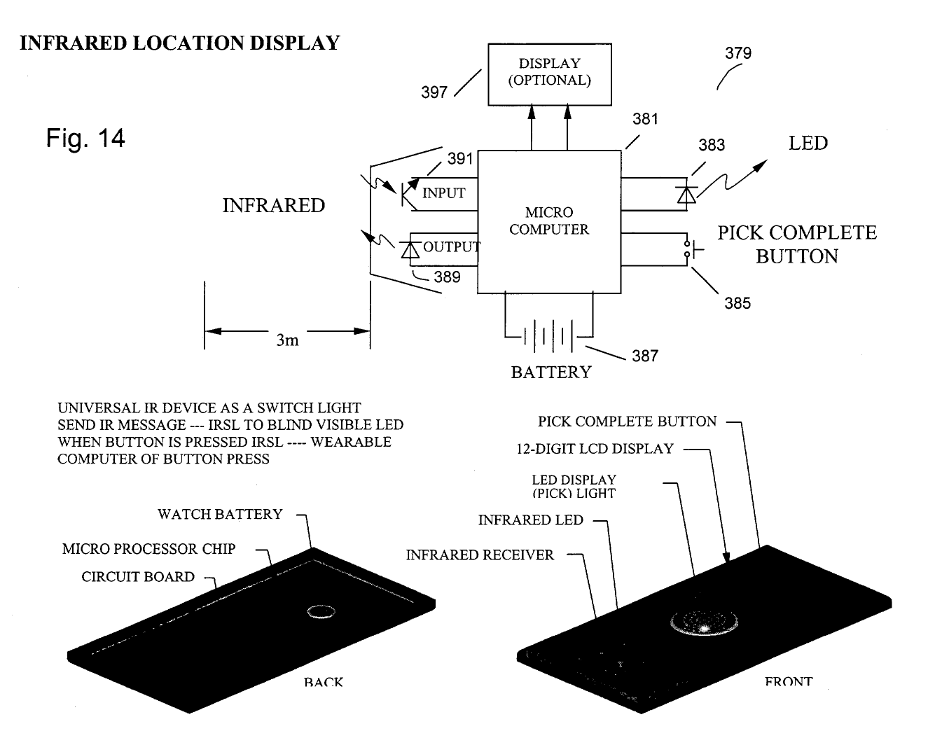

FIG. 14 illustrates an infrared type location display 379 which includes: a microprocessor 381, a battery 387, a pick complete button 385, an LED 383, an LCD display 397, an infrared input 391 and an infrared output 389. The location displays 379 may also include data entry buttons or touch screens. The infrared type location display 379 operates in the same manner as the RF location display 377 described above, but utilized infrared light as a carrier of communications signals with the controlling computer. The infrared input 391 receives the pick signal and the infrared output 389 transmits the pick complete or adjusted pick information to the controlling computer.

Doorbell type location verification devices include “location doorbells” and “doorbell displays.” The primary distinction between the location doorbells and the doorbell displays is that the location doorbells only have a transmitter and can only transmit RF signals. In contrast, the doorbell displays have a transceiver and a visual display. The doorbell display can transmits RF signals and receive pick information from the controlling computer and display information on the visual display.

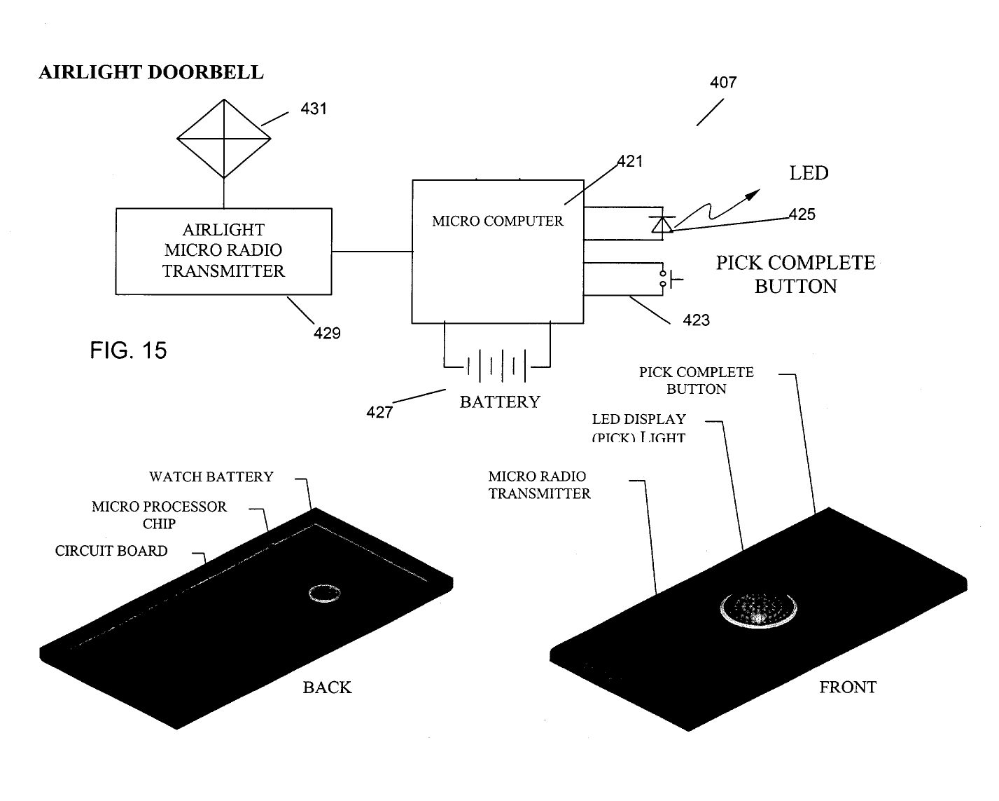

FIG. 15 illustrates an RF embodiment of the “location doorbell” type location verification device. The doorbell 407 contains: a microprocessor 421, a location verification button 423, an LED 425, a battery 427, an RF transmitter 429 and an antenna 431. During the order filling process, the doorbell cannot receive pick information from the controlling computer. The orderfiller receives location information for the inventory item from a visual display, such as a heads-up display or wrist terminal, that is connected to the controlling computer. After locating the inventory item, the orderfiller presses the location verification button 423 and the doorbell 407 transmits a location signal through the RF transmitter 429 to verify that the orderfiller is at the correct location. If the orderfiller pressed the location verification button 423 on the correct doorbell 407, the controlling computer shows the pick quantity on the orderfiller's visual display. The orderfiller removes the specified quantity of the inventory item and confirms the pick using an input device, such as a wrist terminal.

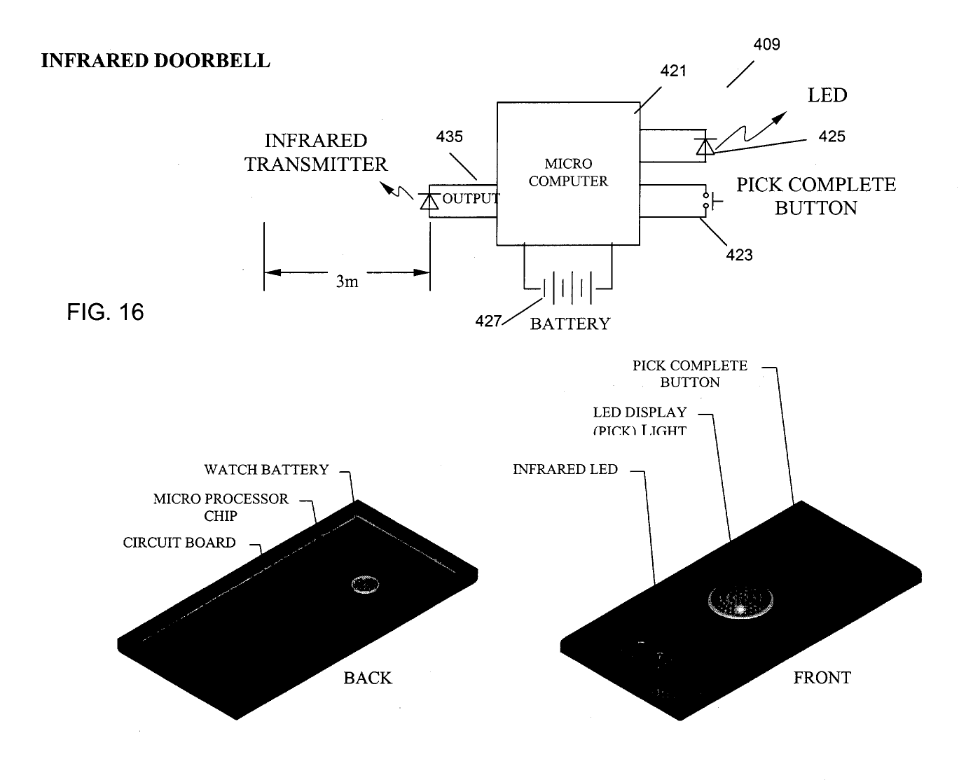

FIG. 16 illustrates an infrared embodiment of the “location doorbell” type location verification device. The infrared doorbells 409 contains: a microprocessor 421, a location verification button 423, an LED 425, a battery 427 and a short range infrared transmitter 435. The infrared doorbell 409 is similar to the RF doorbell 407 but transmits the location signal to the controlling computer through an infrared transmitter 435.

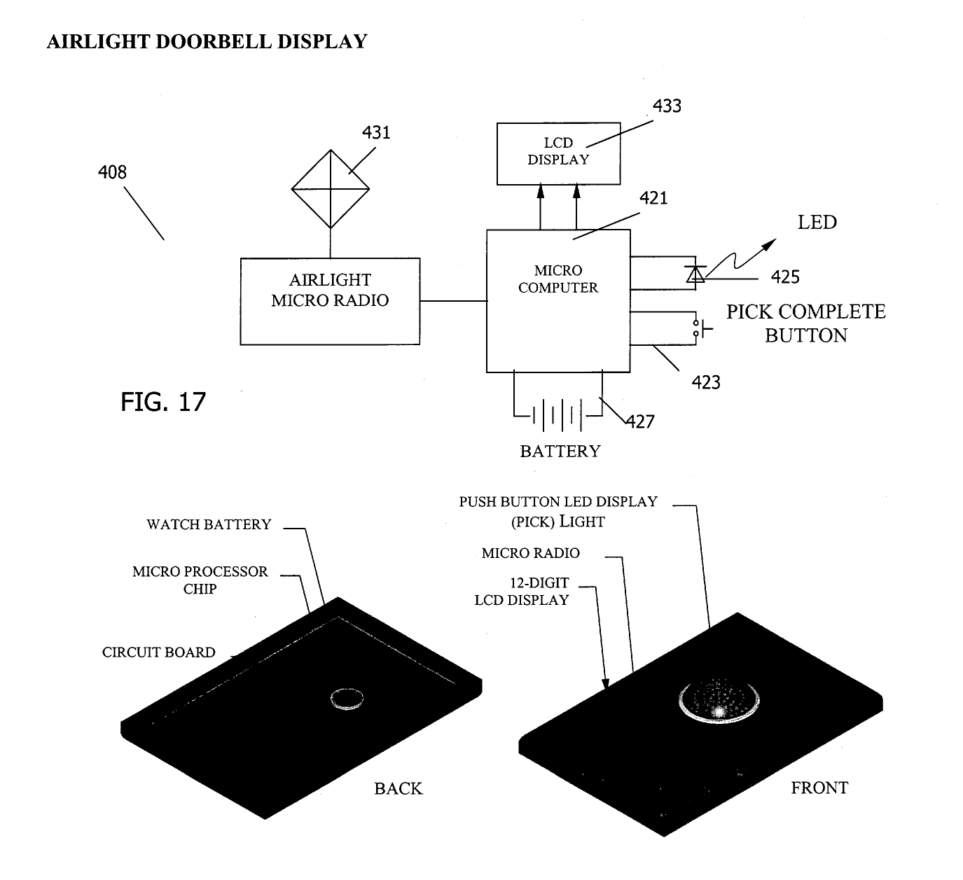

In an embodiment, the doorbell includes a visual display and may be called a “doorbell display” location verification device. The doorbell display is similar to the location doorbell but also includes an RF transceiver for bi-directional communications with the controlling computer. FIG. 17, illustrates a RF embodiment of the doorbell display 408. The doorbell 407 contains: a microprocessor 421, a location verification button 423, an LED 425, a battery 427, an RF transceiver 429, an antenna 431 and a visual display.

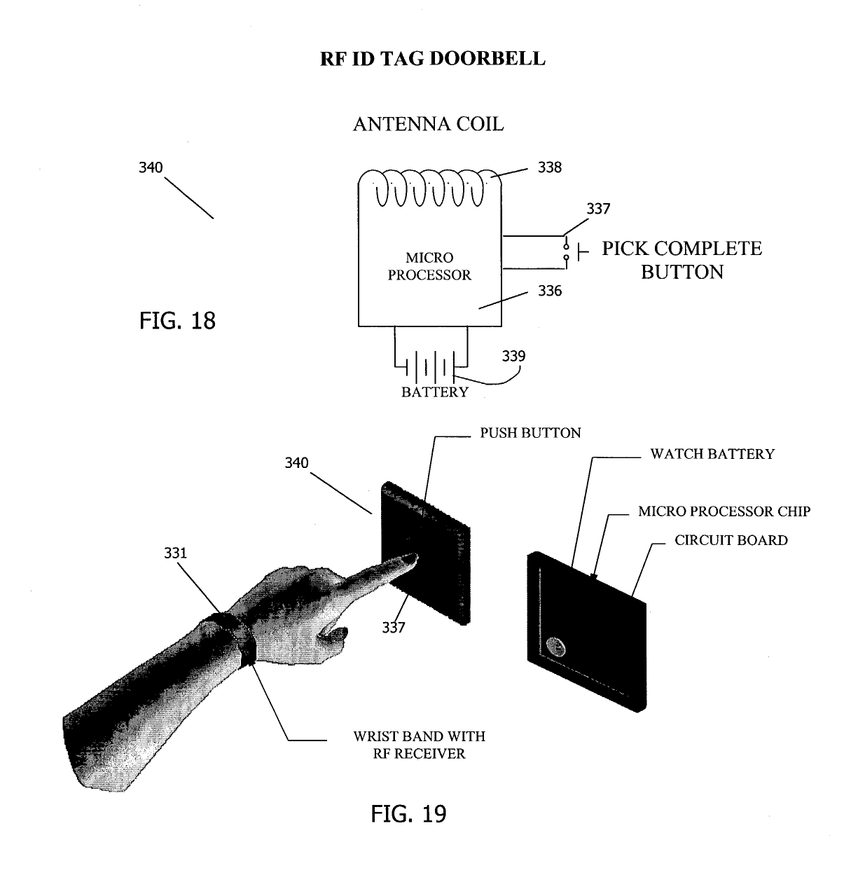

Yet another type of doorbell is the RFID tag doorbell. FIG. 18 illustrates a diagram of the RFID tag doorbell 340 which has a battery 339, a microprocessor 336 a switch button 337 and an antenna coil 338. When the button 337 is actuated, the RFID tag doorbell 340 emits an identification signal. The RFID tag doorbell does not have a receiver, a light or a visual display and can only be used by the orderfiller to confirm the proper inventory item location.

During operation, the doorbell does not initially receive a pick signal and a light on the doorbell is not illuminated to assist the orderfiller in finding the inventory item. The orderfiller is directed to the inventory item location by the controlling computer. When the orderfiller finds the inventory item storage area, the orderfiller presses a “location verification” button on the doorbell. The button pressing wakes up the doorbell display from a low power sleep state. In response, the doorbell transmits a location signal through the transmitter of the location verification device to the controlling computer and a light on the doorbell may be illuminated. If the orderfiller has pressed the correct location verification button on the correct location verification device, the controlling computer confirms that the orderfiller is at the correct location. If the orderfiller presses the wrong location verification button, the controlling computer informs the orderfiller of the wrong location and again directs the orderfiller of the correct location. The described initial operation is the same for both the location doorbell and the doorbell display location verification devices but differs after the location verification button is pressed.

If a location doorbell is being used, the controlling computer informs the orderfiller of the number of inventory items to pick after receiving the correct location signal. The orderfiller presses the “Done” button on an input device of the controlling computer (or the location verification button for a second time) to confirm the pick. The controlling computer then instructs the orderfiller to proceed to the next inventory order item.

If a doorbell display is being used, the controlling computer responds to the correct location signal by transmitting the pick information for the inventory item to the doorbell display. The pick information is then displayed on the visual display of the doorbell display. The orderfiller views the pick information on the visual LCD display and removes the specified quantity of the inventory item. The orderfiller may then press the location verification button or a done button on an input device to confirm the pick. The doorbell display transmits a pick complete signal to the controlling computer and turns off the light on the doorbell. The controlling computer then instructs the orderfiller to proceed to the next inventory order item and the process is repeated.

The doorbell displays are energy efficient because the communications are only actuated when the orderfiller pushes the button on the doorbell display. The doorbells only remain fully active for a limited period of time after the button is pressed. When the doorbell is not in the communications mode, the doorbell display goes into a low power sleep mode. While in the sleep mode, the doorbells do not monitor for RF signals nor do they transmit any information to the controlling computer. The intermittent operation also improves reliability because only active doorbells transmit signals which reduces the background RF communications noise.

The doorbells may conserve additional energy when used with a wristband type RFID receiver. FIG. 19 illustrates a wristband 331 used with an RFID tag doorbell 340. The wristband 331 is worn on the orderfiller's left wrist. When the orderfiller uses the left hand to actuate the button 337 on the RFID tag doorbell 340, the wristband 331 is inherently placed in close proximity to the doorbell 340. Because of the inherent close proximity, the signal output of the RFID tag doorbell 340 can be very small because the signal only needs to travel several inches to the receiver on the wristband 331.

In an embodiment, the RFID tag doorbell includes a microchip with a coiled antenna, and the wristband has an antenna reader that sends out electromagnetic waves that form a magnetic field. When the wristband is placed in close proximity to the RFID tag doorbell, the wristband couples with the RFID tag. The passive RFID tag draws power from this magnetic field and uses it to power the microchip's circuits. The microchip then modulates the RF waves that the tag sends back to the reader and the reader converts the new waves into digital data. In this embodiment, the RFID tag doorbell does not require a battery.

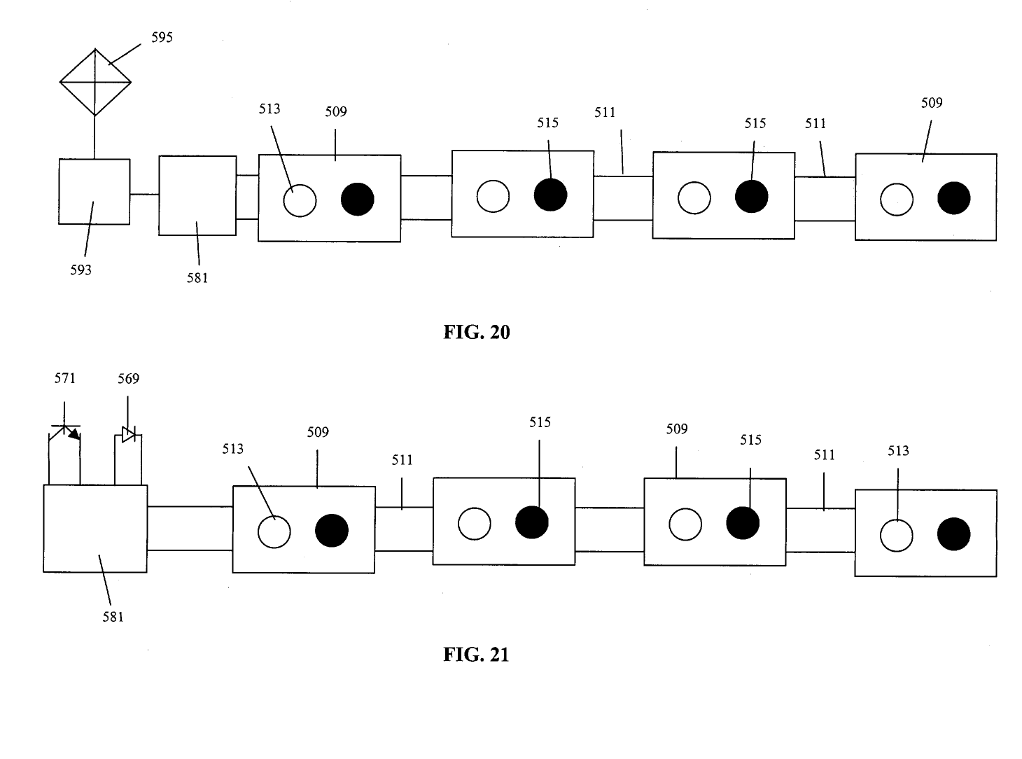

Yet another type of location verification device is the location clip. FIG. 20 illustrates an RF embodiment of the location clip 509 type location verification device mounted on an electrical track 511. The location clips 509 are similar to switchlight type location verification devices but utilize a single RF transceiver, antenna and microprocessor to control communications to multiple location clips 509. During the order filling process, the controlling computer transmits a pick signal which is received by the by the microprocessor through the RF transceiver and antenna. The microprocessor transmits the signal along an electrical track 511 to the multiple location clips 509. The location clip 509 associated with the signal illuminates its LED 513 and all other location clips 509 keep their associated LEDs 513 off. The orderfiller goes to the location clip 509 with the illuminated LED 513, removes the specified quantity of inventory items and presses the pick complete 515 button. A signal is transmitted through the track 511 to the microprocessor 581 and a pick complete signal is transmitted through the RF transceiver 593 and antenna 595 to the controlling computer.

FIG. 21 illustrates an infrared embodiment of the location clip 509 location verification device. The infrared location clip is similar to the RF location clip but utilizes an infrared transmitter 569 to transmit signals to the controlling computer and an infrared receiver 571 to receive signals from the controlling computer instead of RF signals.

As discussed, the location verification device can be mounted on a carrier used to transport multiple containers. The location verification device assists the orderfiller in identifying the proper container to place the picked order items. During the order filling process, the controlling computer sends a signal to the location verification device associated with the order carton (not shown). The LED on the carrier's location verification device illuminates to indicate the carton that is to receive the picked inventory item(s). The orderfiller places the inventory items into the appropriate carton and presses a pick complete button on a location verification device associated with the carton. The location verification device sends a signal to the controlling computer confirming that the inventory items have been placed in the container. Alternatively, a single location display may display the target container for the picked order items.

The type of carrier used may depend upon the size of the order and the number of orders being processed simultaneously. For example, the carrier may be a cart having wheels, a baker's rack, or a carriage type device, which is capable of holding a number of cartons. In applications where the inventory items are large and heavy, the carts have motors that assist the orderfiller in moving the cart. The direction and velocity of the motorized cart could be controlled by the orderfiller or directed by an automated device such as a line follower.

Alternatively, the carrier may be a segmented tote that is pushed by the orderfiller on a gravity conveyor or transported by motorized conveyor. A normal tote carries items for one order and a segmented tote, carries items for multiple orders. Segmented totes are primarily used to transport multiple orders that require smaller inventory items. FIG. 22 illustrates a segmented tote 501 having 8 compartments. The segmented tote 501 may be used in the same manner described with reference to the carrier above, however the segmented tote has tote location clips 509 which are associated with each segment of the tote. The segmented tote 501 has, a microprocessor, battery, a memory and a short range transceiver mounted in a housing 519 and a track 511 that is used to communicate with the tote location clips 509. The tote location clips 509 are similar to location verification devices but include: an LED 513, a pick complete button 515 and electronic contacts to the segmented tote track 511. The segmented tote receives signals from the controlling computer and communicates this signal to the location clips 509. Because the locations clips 509 and partitions in the segmented tote 501 are removable, the segmented tote 501 may be configured with a variable number of partitions and location clips 509. This variable configuration can be performed as orders are assigned to the segmented tote 501.

As discussed, the location clips may be mounted in fixed position in the inventory storage area or on the totes/containers used to transport the picked inventory items. When the location clips are used at fixed positions in the inventory storage area, they may operate like a doorbell type location verification device and only transmit a location verification signal to the controlling computer when the location verification button is pressed. When the orderfiller presses the location clip button a location signal is transmitted to the controlling computer. If the orderfiller is at the incorrect location, the controlling computer will transmit a location error signal to the orderfiller who will then attempt to move to the correct location clip.

Alternatively, the location clip may function like the switchlight type location verification device. When the controlling computer transmits an order signal for the item associated with the location clip, a receiver may obtain the signal and transmit an illumination signal to the location clip. The light of the location clip may then be illuminated to assist the orderfiller in finding the inventory item. The orderfiller may press a pick complete button on the location clip which transmits a location signal to the controlling computer. If the location signal is associated with the correct inventory location the controlling computer may turn the location clip light off.

During order filling processing with segmented totes 501, the orderfiller removes the inventory item and may press the pick complete button on the storage area location verification device on the storage shelf to verify the inventory pick. Alternatively, the orderfiller may press the location clip button 509 to send a location signal to the controlling computer. The controlling computer may respond by transmitting a placement signal to the segmented tote 501 which causes the light of one location clip on the segmented tote to be illuminated. The worker then places the item(s) into the carton associated with the illuminated location clip 509 and presses the pick complete button 515. The segmented tote 501 transmits a signal to the controlling computer to verify that the inventory order item has been placed in the correct segment of the tote.

Power may be supplied to the segmented tote and tote location clips 509 by a rechargeable battery that is connected to external conductors 517 which protrude from an upper surface on the tote 501, other conductors may be mounted directly under the external conductors 517. When the totes 501 are not being used, they may be stacked on a power supply cradle that provides electricity to the conductors 517. The conductors 517 of adjacent totes 501 contact each other so that many batteries of totes 501 may be recharged while stacked and be fully charged when removed for use.

During the order filling process, the controlling computer can only communicate with location verification devices that are within the range of the personal area network (PAN). As discussed, the controlling computer travels with the orderfillers through the inventory storage area. As the controlling computer travels through the storage area the devices which are part of the PAN change because the location verification devices attached to the storage locations move in and out of the PAN range. In a similar manner, location verification devices associated with shipping carton carriers become part of the PAN as the controlling computer is within range of the carrier. The area of the short range communications center around the controlling computer. This area may be a radius of about 3-4 meters depending upon the type of communications being utilized. The PAN may utilize short range RF or infrared signals either of which may be transmitted only a short distance to a controlling computer. The area of the short range communications depends upon the transmission power and communications method. For example, 1 milliwatt signal may travel up to 10 meters and a 100 milliwatt signal may travel up to 100 meters. Lower transmission power is used to improve battery life and because the input and output devices are always in close proximity to the controlling computer. If infrared signals are used, the user interface device must also be within the line of sight of the controlling computer transceiver. In the preferred embodiment, the area of the short range communications center around the controlling computer may be a radius of about 3-4 meters.

In the foregoing, a computer controlled order filling system using wireless communications has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. An order filling system comprising:
a server computer having:
an RF transmitter;
a memory for storing order information;
a controlling computer having:
a memory for storing an order filling program,
an RF transceiver for receiving order information from the server computer and sending pick results to the server computer,
an output device for transmitting at least some of the order information to an orderfiller, and
a proximity receiver;
a location verification device comprising:
a button; and
an RF output device;
wherein the order information transmitted to the controlling computer includes location information and pick quantity information for a plurality of inventory items stored in an inventory storage area.

2. The order filling system of claim 1 wherein when the button is pressed, the RF output device transmits a location or identification signal to the proximity receiver of the controlling computer.

3. The order filling system of claim 1 wherein the location verification device has a communications mode which is actuated when the button is pressed and a low power mode during which the transmitter is not active which is actuated within a limited period of time after the button is pressed.

4. The order filling system of claim 1 wherein the RF output device is a proximity transmitter and the proximity receiver of the controlling computer is mounted in a device worn on the arm of the orderfiller.

5. The order filling system of claim 1 wherein the RF output device of the location verification device is a proximity transmitter having a transmission range of about 12 inches.

6. The order filling system of claim 1 wherein
the location verification device further comprises:
a light; and
the controlling computer further comprises:
a proximity transmitter for transmitting a pick signal to the location verification device;
wherein if the pick signal is received by a proximity receiver associated with the location verification device and the pick signal corresponds with the inventory item associated with the location verification device, the light of the location verification device is illuminated.

7. The order filling system of claim 1 wherein
the controlling computer further comprises:
a proximity transmitter for transmitting a pick signal to the location verification device and
the location verification device further comprises:
a proximity receiver for receiving the pick signal and
a visual display.

8. The order filling system of claim 7 wherein when the button of the location verification device is pressed a proximity transmitter associated with the location verification device transmits a location or identification signal to the proximity receiver of the controlling computer and pick information is transmitted to the proximity receiver from the controlling computer and at least some of the pick information is transmitted to the visual display.

9. The order filling system of claim 1 wherein the location verification device is mounted on or adjacent to the inventory storage area of one of the inventory items.

10. The order filling system of claim 1 wherein the output device comprises a wireless receiver for receiving pick information from the controlling computer.

11. The order filling system of claim 1 wherein the controlling computer further comprises a touch screen mounted on a wrist terminal.

12. The order filling system of claim 1 wherein the controlling computer further comprises a microphone and a voice recognition system.

13. The order filling system of claim 1 wherein the controlling computer further comprises a barcode scanner or an RFID reader.

14. The order filling system of claim 1 wherein the output device of the controlling computer is a visual display.

15. The order filling system of claim 14 wherein the visual display is a heads up display or an alphanumeric display mounted on a wristband.

16. The order filling system of claim 1 further comprising:
a carrier for transporting some of the inventory items;
wherein the location verification device is mounted on the carrier.

17. The order filling system of claim 16 further comprising:
a container for transporting some of the inventory items which are transported by the carrier.

18. The order filling system of claim 1 further comprising:
a tote comprising:
one or more compartments;
a proximity receiver for receiving information from the controlling computer, and
one or more location clips associated with the one or more compartments of the tote, each location clip comprising:
a button, and
a light.

19. The order filling system of claim 18 wherein if the pick complete button of the associated location clip is pressed, a place complete signal is transmitted from a proximity transmitter associated with the location clip to the controlling computer.

20. The order filling system of claim 18 wherein the tote is powered by a battery or a solar cell.

21. The order filling system of claim 1 further comprising:
a plurality of totes, each comprising:
one or more compartments;
a rechargeable battery; and
electrical contacts;
wherein the totes are stackable, the electrical contacts of adjacent stacked totes engage each other and the batteries of the stacked totes are recharged when the totes are placed in a recharger.

22. The order filling system of claim 1 wherein the location verification device is one of a plurality of location clips each comprising a light and a button, the plurality of location clips are in electrical communications with a location clip proximity receiver and a location clip proximity transmitter.

23. The order filling system of claim 22 wherein when a pick signal is received by the proximity receiver the light of a locations clip associated with the pick signal is illuminated and when the button of the location clip associated with the pick signal is pressed a pick complete signal is transmitted from the proximity transmitter to the controlling computer.

24. The order filling system of claim 1 wherein the location verification device includes a passive RFID tag which receives electromagnetic energy from an outside source and converts the electromagnetic energy into an identification signal which is transmitted to the proximity receiver of the controlling computer.

25. The order filling system of claim 1 wherein the location verification device is powered by a battery or a solar cell.

26. An order filling system comprising:
a controlling computer comprising:
a memory for storing an order filling program and order information;
an output device for transmitting some of the order information to an orderfiller; and
a proximity receiver; and
a location verification device comprising:
an output device.

27. The order filling system of claim 26 wherein the location verification device further comprises an input device and the output device is an RF transmitter which transmits an identification signal to the proximity receiver of the controlling computer when the input device is actuated.

28. The order filling system of claim 26 wherein the location verification device further comprises an input device and the location verification device has a communications mode which is actuated when the input device is actuated and a low power mode during which is actuated within a limited period of time after the input device is actuated.

29. The order filling system of claim 26 wherein the output device is an RF proximity transmitter and the proximity receiver of the controlling computer is mounted in a device worn by the orderfiller.

30. The order filling system of claim 26 wherein the output device is an RF proximity transmitter with a transmission range of less than about 12 inches.

31. The order filling system of claim 26 wherein the order information includes location information and pick quantity information for an inventory order item.

32. The order filling system of claim 26 wherein the output device is not physically attached to the controlling computer and comprises a wireless receiver for receiving pick information from the controlling computer.

33. The order filling system of claim 26 wherein the controlling computer further comprises a touch screen which allows the orderfiller to input information to the controlling computer.

34. The order filling system of claim 26 wherein the controlling computer further comprises a microphone and a voice recognition system which allow the orderfiller to input information to the controlling computer.

35. The order filling system of claim 26 wherein the controlling computer further comprises a barcode scanner or an RFID reader.

36. The order filling system of claim 26 wherein the output device of the controlling computer is a visual display.

37. The order filling system of claim 26 wherein the output device of the controlling computer is a heads up display or an alphanumeric display mounted on a wristband.

38. The order filling system of claim 26 wherein the location verification device is mounted on or adjacent to the inventory storage area of an inventory item.

39. The order filling system of claim 26 wherein the location verification device or location clip is powered by a solar cell.

40. The order filling system of claim 26 wherein the location verification device or location clip is powered by a rechargeable battery or a solar cell.

41. The order filling system of claim 26 wherein the location verification device includes a passive RFID tag which receives electromagnetic energy from an outside source and converts the electromagnetic energy into an identification signal which is transmitted through the output device to the proximity receiver of the controlling computer.

42. A method of filling an order comprising the steps:
providing an order filling system comprising: a controlling computer comprising: an output device, a proximity receiver, a memory for storing an order filling program and order information; and a location verification device comprising an input device;
transmitting some of the order information through the output device to an orderfiller to instruct the orderfiller of the location of an order item and the pick quantity of the order item; and
transmitting a location or identification signal from a proximity transmitter which is associated with the location verification device to the controlling computer when the input device is actuated.

43. The order filling system of claim 42 further comprising the step:
pressing the button on the location verification device before transmitting the location or identification signal.

44. The order filling system of claim 43 further comprising the steps:
placing the location verification device into a communications mode immediately after the pressing the button step
placing the location verification device into a low power mode of operation a limited period of time after the pressing the button step.

45. The order filling system of claim 42 further comprising the step;
placing the proximity receiver of the controlling computer within about 12 inches of the location verification device during the transmitting the location or identification signal step.

46. The order filling system of claim 42 further comprising the step;
providing electromagnetic energy from an outside source to the location verification device; and
converting the electromagnetic energy into the location or identification signal.

47. The method of filling an order of claim 42 further comprising the step:
transmitting an error signal to the output device of the controlling computer if the location or identification signal does not correspond to the proper location of the order information.
